(19) United States
(12) Patent Application Publication
(10) Pub. No.: US 2013/0056188 A1
(43) Pub. Date: Mar. 7, 2013

(54) COOLING STRUCTURE

(71) Applicants: Leo Gard, Sherman Oaks, CA (US); Marcelo Bromberg, Simi Valley, CA (US); Cheng-Yi Lu, West Hills, CA (US); Micahel Mowry, Castaic, CA (US); Timothy Welch, Los Angeles, CA (US)

(72) Inventors: Leo Gard, Sherman Oaks, CA (US); Marcelo Bromberg, Simi Valley, CA (US); Cheng-Yi Lu, West Hills, CA (US); Micahel Mowry, Castaic, CA (US); Timothy Welch, Los Angeles, CA (US)

(73) Assignee: Hamilton Sundstrand Space Systems International Inc., Windsor Locks, CT (US)

(21) Appl. No.: 13/476,478

(22) Filed: May 21, 2012

Related U.S. Application Data
(63) Continuation-in-part of application No. 13/224,414, filed on Sep. 2, 2011.

(51) Int. Cl. F28F 3/14; B23P 15/26

(52) U.S. Cl. 165/170; 29/890.03

(57) ABSTRACT

A panel for forming a heat exchanger structure includes a first end; a second end; a first side to connect to another adjacent panel; a second side to connect to an adjacent panel; a first surface between the first and second ends and the first and second sides; a second surface between the first and second ends and the first and second sides; and a circular flow passage extending from the first end to the second end, wherein the panel is an extruded monolithic structure.

### CROSS-REFERENCE TO RELATED APPLICATION

This is a continuation-in-part application of U.S. patent application Ser. No. 13/224,414, with a filing date of Sep. 2, 2011, the entire contents of which is herein incorporated by reference.

### BACKGROUND

The present invention relates to cooling structures, and in particular, to cooling structures which a fluid can flow through.

Traditional cooling structures, for example a radiator or a cooling plate, are heat exchangers used to transfer thermal energy from one medium to another. These heat exchangers typically rely on attaching coolant tubes to a plate to transfer heat to fluid running through the tubes. The cooling tubes are typically attached using thermally conductive epoxies, gaskets, brazed joints, or solder joints.

### SUMMARY

A panel for forming a heat exchanger structure includes a first end; a second end; a first side to connect to another adjacent panel; a second side to connect to an adjacent panel; a first surface between the first and second ends and the first and second sides; a second surface between the first and second ends and the first and second sides; and a circular flow passage extending from the first end to the second end, wherein the panel is an extruded monolithic structure.

A method of forming a heat exchanger structure includes forming a plurality of extrusion panels, each panel extruded as a monolithic part with a first end, a second end, a first side to connect to an adjacent panel, a second side to connect to another adjacent panel, a first surface between the first and second ends and the first and second sides, a second surface between the first and second ends and the first and second sides, and a circular flow passage extending from the first end to the second end; joining the plurality of extrusion panels together by connecting the first side of a panel to the second side of the adjacent panel; and joining the flow passages of each panel together with a plurality of headers to form a flow path through the plurality of flow passages

### BRIEF DESCRIPTION OF THE DRAWINGS

FIG. 1A is a perspective view of a panel modular segment of a cooling structure.

FIG. 1B is a perspective view of one panel of the modular segment of FIG. 1.

FIG. 1C is a cross-sectional view along section 2-2 of the cooling structure of FIG. 1.

FIG. 2 is a cross-sectional view of a second embodiment of a panel for a cooling structure.

### DETAILED DESCRIPTION

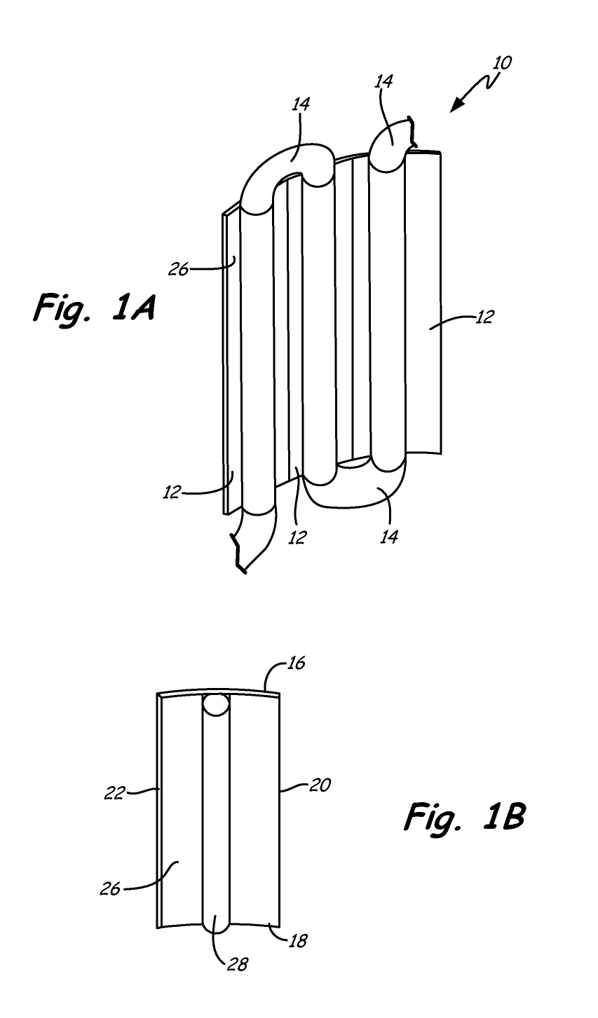

FIG. 1A is a perspective view of a panel modular segment of a cooling structure 10, FIG. 1B is a perspective view of panel 12, and FIG. 1C is a cross-sectional view of panel 12. Cooling structure 10 includes three monolithic extruded panels 12 and headers 14. Each panel 12 includes a first end 16, second end 18, first side 20, second side 22, first surface 24, second surface 26 and circular flow passage 28.

Panel 12 can be formed by shaping or extruding a profile to define flow passages 28 as a monolithic part. Panel 12 can be formed of aluminum (including alloys) or another material depending on system requirements. Panels 12 are connected another adjacent panel 12 at first side 20 and second side 22. First side 20 of each panel can be a complementary shape to second side 22 of each panel 12, so that first side 20 of one panel 12 connects securely to second side 22 of an adjacent panel 12. Panels can also be welded together at first side 20 and second side 22.

In the example shown, flow passages 28 extend out of second surface 26, leaving first surface 24 smooth. Flow passages 28 extend from first end 16 to second end 18, and are linear with a central axis that is parallel to or aligned with panel 12. Flow passages 28 are generally parallel with other flow passages 28 when a plurality of panels 12 are connected together. Headers 14 are welded onto first end 16 and second end 18 of cooling structure to join alternating flow passages 28. Alternatively, headers 14 can be bolted or secured by other means, or can join flow passages 28 in a different configuration, depending on system requirements. In the embodiment of FIG. 1A, each panel 12 is curved slightly inward towards second side 26. Cooling structure 10 can be joined with other extrusions modularly to form a cooling structure, which can be a complete cylinder radiator or a different shape depending on the application. Cooling structure 10, and in particular the first side 12, may be placed in thermal contact with a heat producing source to be cooled. Alternate embodiments can include flat panels 12.

Cross-sections of flow passages 28 are circular in the shape. Cross-sections are extruded to define flow passage shape and size according to the amount of heat exchange required. Additional considerations for forming panel 12 cross-sections can be motor size for the pumping of fluid through flow passages 28 and size and shape of area or article needing heat exchange and space available for flow passages 28.

Cooling structure 10 acts as a heat exchanger to transfer heat from first surface 24 to fluid flowing through flow passages 28. Headers 14 connect flow passages 28 so that the plurality of flow passages 28 form a serpentine flow path to circulate a coolant.

By forming cooling structure 10 with a plurality of panels 12 that are each a monolithic extruded piece with a circular flow passage 28, cooling structure can efficiently act as a heat exchanger and can be easily manufactured. By extruding panels 12 individually, the individual extrusions are relatively small, and do not require a special over-sized extrusion press. By making first side 20 and second side 22 complementary, a plurality of panels can be connected together to provide the amount of heat exchange needed. Additionally, having circular flow paths allows for easy connections between flow passages 28 and headers 14.

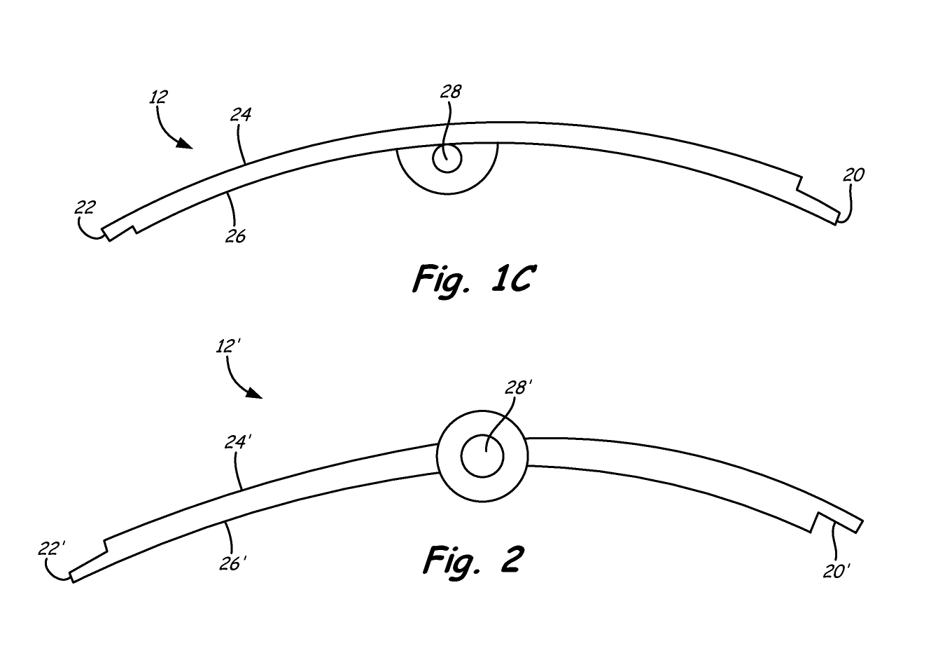

FIG. 2 is a cross-sectional view of a second embodiment of a panel 12′ for a cooling structure. Panel 12′ includes first side 20′, second side 22′, first surface 24′, second surface 26′ and circular flow passage 28′.

Panel 12′ is extruded as one monolithic part and can be joined with other panels 12′ to form a cooling structure. Flow passage 28′ is in line with panel 12′ between first surface 24′ and second surface 26′.

Flow passage 28′ can work well in an environment where cooling is needed on both surfaces 24′ and 26′ of heat exchanger. Panel 12′ exposes flow passage 28′ to both surfaces 24′, 26′ for heat exchange. Forming flow passages 28′ inline with panel 12′ additionally gives heat exchanger a lower profile, allowing use in applications with a limited amount of space for cooling structure 10.

In summary, by forming cooling structure 10 with monolithic extruded panels 12, 12′, cooling structure can be a light-weight, easily manufacturable and efficient heat exchanger. Panels 12, 12′ include circular flow passage 28, 28′ for efficient heat exchange, and their circular shape makes them easily connectable to headers 14. Extruded panels 12, 12′ include first and second sides 20, 20′, 22, 22′ which are complementary to allow joining of a plurality of panels 12, 12′ to obtain the cooling desired for system. Extruding panels 12, 12′ only allows for a more adaptable heat exchanger, as the extrusion is small and easy to do without the need for an oversized extrusion press. Cooling structure segment 10 can be used as a space radiator (with thermal energy transferred from fluid flow inside flow passage 28, 28′ panels 12, 12′) for a space vehicle, to cool electronics with high power densities or any other situations where heat exchange is needed.

While cooling structure 10 is shown to have a curve, alternative embodiments can have a larger curve, smaller curve or no curve at all. Additionally, the size, number and shape of flow passages 28′ may vary in different applications.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A panel for forming a heat exchanger structure, the panel comprising:
a first end;
a second end;
a first side to connect to an adjacent panel;
a second side to connect to another adjacent panel;
a first surface between the first and second ends and the first and second sides;
a second surface between the first and second ends and the first and second sides; and
a circular flow passage extending from the first end to the second end, wherein the panel is an extruded monolithic structure.

2. The panel of claim 1, wherein the first side is complementary to the second side so that a plurality of panels can be connected together at the sides.

3. The panel of claim 1, wherein the circular flow passage is in line with the panel equally between the first surface and the second surface.

4. The panel of claim 1, wherein the circular flow passage is recessed from the panel so that the first surface is smooth and the second surface includes the flow passage.

5. The panel of claim 1, wherein the extruded monolithic structure is aluminum.

6. The panel of claim 1, wherein the flow passage is located equidistant between the first side and the second side.

7. The panel of claim 1, wherein the panel is a curved segment.

8. A heat exchanger structure comprising:
a plurality of monolithic extrusion panels connected together, each monolithic extrusion panel comprising:
a first end;
a second end;
a first side to connect to an adjacent panel;
a second side to connect to another adjacent panel;
a first surface between the first and second ends and the first and second sides;
a second surface between the first and second ends and the first and second sides; and
a circular flow passage extending from the first end to the second end; and
a plurality of headers connecting the plurality of flow passages to form a flow path through the plurality of flow passages, wherein all flow passages are parallel to each other when the plurality of panels are attached.

9. The structure of claim 8, wherein each of the extrusion panels is aluminum.

10. The structure of claim 8, wherein the first side of each extrusion panel is complementary to the second side of each extrusion panel.

11. The structure of claim 8, wherein the extrusion panels are welded together at the sides.

12. The structure of claim 8, wherein the circular flow passage in each of the extrusion panels is in line with the extrusion panel equally between the first surface and the second surface.

13. The structure of claim 8, wherein the circular flow passage in each of the extrusion panels is recessed from the extrusion panel so that the first surface of each of the extrusion panels is smooth and the second surface of each of the extrusion panels includes a flow passage.

14. The structure of claim 8, wherein the headers connect alternating pairs of the plurality of flow passages.

15. The structure of claim 8, wherein each of the extrusion panels is a curved segment.

16. The structure of claim 8, wherein the flow path through the plurality of flow passages is serpentine.

17. A method of forming a heat exchanger structure comprising:
forming a plurality of extrusion panels, each panel extruded as a monolithic part with a first end, a second end, a first side to connect to an adjacent panel, a second side to connect to another adjacent panel, a first surface between the first and second ends and the first and second sides, a second surface between the first and second ends and the first and second sides, and a circular flow passage extending from the first end to the second end; and
joining the plurality of extrusion panels together by connecting the first side of a panel to the second side of the adjacent panel; and
joining the flow passages of each panel together with a plurality of headers to form a flow path through the plurality of flow passages.

18. The method of claim 17, wherein the step of forming a plurality of extrusion panels comprises forming each of the extrusion panels so that the first surface is smooth and the second surface contains the flow passage.

19. The method of claim 17, wherein the step of forming a plurality of extrusion panels comprises forming each extrusion panel so that the flow passage extends into both the first surface and the second surface.

20. The method of claim 9, wherein the step of joining the plurality of extrusion panels together comprises welding the sides of the plurality of panels together.
